(19) United States
(12) Patent Application Publication
(10) Pub. No.: US 2009/0304991 A1
(43) Pub. Date: Dec. 10, 2009

(54) SURFACE-MODIFIED PLASTIC FILM AND PROCESS FOR PRODUCING THE SAME

(75) Inventors: Akihiko Tanioka, Tokyo (JP); Mie Minagawa, Tokyo (JP); Hidetoshi Matsumoto, Kanagawa (JP); Hirotaka Arai, Aichi (JP); Atsushi Obayashi, Tokyo (JP); Ken Tashiro, Aichi (JP); Satoru Momohira, Aichi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Mitsubishi Chemical MKV Company, Minato-ku (JP)

(21) Appl. No.: 12/065,092

(22) PCT Filed: Sep. 2, 2005
(86) PCT No.: PCT/JP2005/016093

§ 371 Date: Jul. 8, 2008

(51) Int. Cl. B32B 3/24; B32B 27/00; B32B 5/16; B05D 1/12; B32B 7/02

(52) U.S. Cl. 428/138; 428/411.1; 428/688; 428/323; 427/580; 428/212

(57) ABSTRACT

A surface-modified plastic film, comprising: a surface layer composed of minute filamentous forms and/or granular forms consisting of a composition containing a resin and/or inorganic microparticles, on at least one major surface of a substrate plastic film. Preferably, the surface-modified plastic film is characterized in that the minute filamentous forms have a diameter of 100 μm to 1 nm.

### TECHNICAL FIELD

The present invention relates to a surface-modified plastic film including a surface layer formed on the electrically insulating plastic film, wherein the surface layer contains a resin and/or microparticles for adding to the electrically insulating plastic film so-called functions such as anti-fogging properties, stain resistance, water repellency or specific-ray reflecting properties. In particular, the invention relates to a surface-modified plastic film as described above, wherein the surface layer having those functions is formed, on part of the electrically insulating plastic film surface, in the form of minute filaments and/or granules of the resin or inorganic microparticles, preferably to an anti-fogging film, and to an agricultural film which is one of the applications the anti-fogging film has.

### BACKGROUND ART

There have been known, as function-added films for use in agricultural films, building films such as decorative films or optical equipment such as anti-reflection films, films including: a flexible plastic film, such as a vinyl chloride resin film or olefin resin film; and a coated surface layer, formed on the flexible plastic film, which is for adding to films functions such as anti-fogging properties, stain resistance or water repellency.

For example, in agricultural films used for covering greenhouses in promoting cultivation of crops, a phenomenon is a big problem that vapor in the air in the inside of warm greenhouses adheres to the inside face of the agricultural films and forms droplets there, thereby deteriorating the transparency of the films. Thus, addition of anti-fogging properties is needed to prevent the occurrence of such a phenomenon.

For techniques for adding anti-fogging properties, methods have been used in which a hydrophilic material such as a surfactant is incorporated in a resin or in which a coating film containing a resin and inorganic colloidal particles is formed on the surface of a resin film. Concrete examples of the latter methods include: a method in which a solution or dispersion of a resin and inorganic colloidal particles in a solvent is coated on the surface of a resin film by the contact with a roll coater; and a method in which a solution or dispersion of a resin and inorganic colloidal particles in a solvent is coated on a resin film by dipping the resin film in the solution bath (Patent Document 1).

The method in which a surfactant is incorporated in a resin, however, poses the problem of allowing the surfactant to flow out with time, resulting in lowered effect, though the time it takes to develop anti-fogging properties is short, whereas the method in which a coating film containing a resin and inorganic colloidal particles is formed is also insufficient to provide satisfactory anti-fogging properties.

Patent Document 1: Japanese Patent Publication (KOKOKU) No. 1-2158)

Accordingly, the object of the present invention is to provide a surface-modified plastic film to which functions, such as satisfactory anti-fogging properties, have been added.

The present inventors presumed that in a surface-modified plastic film which is produced for adding functions, such as anti-fogging properties, to a plastic film, the hydrophobic or hydrophilic resin coating need not be deposited uniformly on the whole surface of the film; rather, the droplet flowing-out effect is increased when the hydrophobic or hydrophilic resin deposited is dispersed in very small regions. They also presumed that very small irregularities formed on the plastic film surface are useful for further increasing the droplet flowing-out effect. Actually, however, there has been no method of controlling such dispersion or irregularities in regions as small as near nano-order, and hence no surface-modified film as described above could be obtained.

Under those circumstances, the present inventors gave various considerations to finding such a controlling method, and they tried applying electrospray deposition method, which has been used in the process for preparing microchips where macromolecules such as proteins are deposited on a conductive material. As a result, they found that the use of the electrospray deposition method makes it possible to apply, onto a substrate plastic film, droplets of the solution or dispersion containing a resin, and moreover, droplets of the solution or dispersion containing a resin together with inorganic microparticles, if special treatment is provided to the substrate plastic film, and preferably to give a surface layer on which a resin composition is deposited in a pattern of an arbitrary form such as a filamentous form. They finally arrived at the present invention.

### DISCLOSURE OF THE INVENTION

The outline of the present invention is providing:

(1) a surface-modified plastic film, comprising: a surface layer composed of minute filamentous forms and/or granular forms consisting of a composition containing a resin and/or inorganic microparticles, on at least one major surface of a substrate plastic film;
(2) the surface-modified plastic film according to (1), wherein the surface layer is formed by deposition;
(3) the surface-modified plastic film according to (1) or (2), wherein the substrate plastic film detected contains an antistatic agent.
(4) the surface-modified plastic film according to any one of (1) to (3), further comprising a conductive film between the substrate plastic film and the surface layer;
(5) the surface-modified plastic film according to any one of (1) to (4), wherein the surface of the substrate plastic film on which the surface layer is to be formed is treated with an antistatic agent;
(6) the surface-modified plastic film according to any one of (1) to (5), further comprising a primer layer between the substrate plastic film and the surface layer;
(7) the surface-modified plastic film according to any one of (1) to (6), wherein the substrate plastic film is a perforated film;
(8) the surface-modified plastic film according to any one of (1) to (7), wherein the minute filamentous forms and/or granular forms are 100 μm to 1 nm in diameter;
(9) the surface-modified plastic film according to any one of (1) to (8), wherein the minute filamentous forms are arranged regularly at least in one direction on the electrically insulating film;
(10) the surface-modified plastic film according to any one of (1) to (9), wherein the surface layer is formed by electrospray deposition method;
(11) the surface-modified plastic film according to any one of (1) to (10), wherein the resin is a hydrophobic or hydrophilic resin, and said plastic film is provided with anti-fogging properties;
(12) the surface-modified plastic film according to any one of (1) to (11), wherein the resin is a hydrophobic or hydrophilic resin, and said plastic film is provided with water repellency;
(13) the surface-modified plastic film according to any one of (1) to (12), wherein the composition is a resin composition having a refractive index different from that of the substrate plastic film and reflects light having a specific wavelength;
(14) a process for preparing a surface-modified plastic film, comprising spraying droplets of a solution or dispersion containing a resin and/or inorganic microparticles using electrospray deposition, on at least one major surface of a substrate plastic film, around which a conductive material is arranged in a manner to surround a periphery of the substrate plastic film, whereby a surface layer composed of minute filamentous forms and/or granular forms consisting of a composition containing the resin and/or inorganic microparticles being formed on a surface of said substrate film;
(15) a process for preparing a surface-modified plastic film, comprising spraying droplets of a solution or dispersion containing a resin and/or inorganic microparticles using electrospray deposition, on at least one major surface of a substrate plastic film whose electrically insulating properties is lowered, whereby a surface layer composed of minute filamentous forms and/or granular forms consisting of a composition containing the resin and/or inorganic microparticles being formed on a surface of said substrate film; and
(16) a process for preparing a surface-modified plastic film, comprising spraying droplets of a solution or dispersion containing a resin and/or inorganic microparticles using electrospray deposition, on one major surface of a perforated substrate plastic film, said surface being opposite to a surface on which a conductive material is arranged, whereby a surface layer composed of minute filamentous forms and/or granular forms consisting of a composition containing the resin and/or inorganic microparticles being formed on a surface of said substrate film.

The present invention provides a surface-modified plastic film wherein a resin composition provided with arbitrary functions, such as anti-fogging properties, is deposited, on part of the surface, in the form of structures as small as near nano-order; therefore, the invention makes it possible to provide a plastic film to which arbitrary functions, such as anti-fogging properties, stain resistance, water repellency or specific-ray reflecting properties, have been added.

### BEST MODE FOR CARRYING OUT THE INVENTION

In the following the present invention will be described in detail in a non-limited manner.

The surface-modified plastic film of the present invention means a plastic film including a surface layer composed of minute filamentous forms and/or granular forms consisting of a composition containing a resin and/or inorganic microparticles, on at least one major surface of a substrate plastic film by deposition.

### Substrate Plastic Film

For the substrate plastic film in the present invention, a general type of resin film, particularly preferably a thermoplastic resin film is used. The thermoplastic resin film means a film prepared using, as a main component, an ordinary thermoplastic resin which is used for agricultural films, building films, optical films or packaging films. Such a film may be a flexible film or a rigid film, but particularly preferably it is a flexible film.

Examples of thermoplastic resins include: vinyl chloride resins; polyolefin resins such as polyethylene, polypropylene and ethylene-vinyl acetate copolymers; polyester resins such as polyethylene terephthalate (PET), polystyrene resins; acrylonitrile-styrene resins; acrylonitrile-butadiene-styrene resins; methylene methacrylate resins; PPO, PPE resins; polyacetal resins; polycarbonate resins; polyphenylene sulfide resins; polyamide resins; fluorine resins; and thermoplastic elastomer resins. Preferable are vinyl chloride resins, polyolefin resins and polyester resins.

The films of the present invention mean films having a thickness generally known as that of films or sheets. Specifically, a film can be arbitrarily selected from films having a thickness in the range of 0.005 mm to 10 mm as its usage. However, to effectively deposit a charged resin on the film surface by the electrospray deposition of the present invention, the thinner substrate film, the more preferable. Preferably films having a thickness in the range of 0.01 mm to 5 mm are used. More preferably films having a thickness in the range of 0.03 mm to 0.5 mm are used.

The films of the present invention are not limited to single-layer films. The films may be those prepared from a blend of two or more kinds of resins or multi-layer films having two or more layers of different kinds of resins, depending on the applications for which the films are used. Further, to improve the adhesion of a resin which is to be deposited on the film by the electrospray deposition method or to improve the deposition efficiency, the films may be subjected to pretreatment, such as corona treatment, plasma treatment or primer treatment, before doing the surface treatment by the electrospray deposition method. Examples of resins usable in primer treatment include: acrylic resins, urethane resins, silicon resins, acrylic urethane resins, acrylic silicon resins, acrylic modified polyolefin resins, vinyl chloride resins, vinyl chloride-vinyl acetate resins, and polyester resins.

The thermoplastic resin films of the present invention can contain any additives besides a thermoplastic resin as a main component. Examples of additives include: plasticizer, ultraviolet light absorber, light stabilizer, antioxidant, thermal stabilizer, heat insulating agent, lubricant, colorant, anti-blocking agent, anti-fogging agent and anti-misting agent.

Ordinary thermoplastic resins, which are used as a substrate plastic film, are usually electrically insulating. In the present invention, to lower the electrically insulating properties of the surface of the substrate plastic film on which a surface layer is to be formed (to lower the inherent surface resistance), an antistatic agent can be added to the substrate film.

Examples of antistatic agents include: conductive fillers such as metal based conductive fillers, non-metal based conductive fillers and carbon based conductive fillers; and organic antistatic agents. Examples of metal based conductive fillers include: conductive fillers of Ag, Cu, Al, Ni, Sn, Fe, Pb, Ti, Mo, W, Ta, Nb, Pt, Au, Pd, Cu—Sn alloys or Cu—Zn alloys. Examples of non-metal based conductive fillers include: conductive fillers of conductive metal oxide such as zinc oxide, titanium oxide, tin oxide or indium oxide; and conductive fillers of barium sulfate, aluminum borate, titanium black or potassium titanate. Examples of carbon based conductive fillers include carbon black. For organic antistatic agents, various types of materials known as antistatic agents of polymeric material can be used. Examples of such antistatic agents include: various types of surfactants, such as cationic (e.g. quaternary ammonium salt type, phosphonium salt type and sulfonium salt type), anionic (e.g. carboxylic acid type, sulfonate type, sulfate type, phosphate type and phosphite type), amphoteric (e.g. sulfobetaine type, alkylbetaine type and alkylimidazolium betaine type) or nonionic (e.g. polyhydric alcohol derivatives, β-cyclodextrin inclusion compounds, sorbitan fatty acid monoester/diester, polyalkylene oxide derivatives and amine oxides); ion-conductive polymers such as homopolymers of monomers having an ion-conductive group of cation type (e.g. quaternary ammonium salt), amphoteric type (e.g. betaine compounds), anion type (e.g. sulfonates) or nonion type (e.g. glycerin) or copolymers of the above monomers and other monomers, and polymers having a moiety originated from acrylate or methacrylate having a quaternary ammonium salt group; and permanent antistatic agents of a type where an acrylic resin is made an alloy with a hydrophilic polymer such as a polyethylene methacrylate copolymer. The content of an antistatic agent in the substrate plastic film is appropriately determined depending on the level to which the electrically insulating properties are lowered.

In the present invention, the electrically insulating properties of the surface of the substrate plastic film on which a surface layer is to be formed can also be lowered by treating the surface with an antistatic agent. In this case, it is preferable to use a spray fluid containing an antistatic agent. For the type of antistatic agents, the organic antistatic agents described above are suitably used.

In the present invention, the electrically insulating properties of the surface of the substrate plastic film on which a surface layer is to be formed can also be lowered by forming, on the surface, a film containing one of the antistatic agents described above. Such a film can be formed by applying, to the surface, a coating agent composed of a blend of a solution or dispersion of a resin having good adhesion to the substrate plastic film with an antistatic agent by a commonly used coating method. Examples of resins used for forming such a film include: acrylic resins, urethane resins, silicon resins, acrylic urethane resins, acrylic silicon resins, acrylic modified polyolefin resins, polyolefin resins, vinyl chloride resins, vinyl chloride-vinyl acetate resins, polyester resins, and fluorine resins. The content of an antistatic agent, in this case, is 5 to 70 parts by weight and preferably 10 to 50 parts by weight per 100 parts of resin that constitutes the coating agent.

Further, in the present invention, the conductivity of the surface of the substrate plastic film can be enhanced by forming on the surface a film composed of a conductive resin. Examples of conductive resins include: polythiophene resins, polyacetylene resins, polyaniline resins, polypyrrole resins, and polyphenylene vinylene resins.

### Surface Layer

The surface layer which the surface-modified film of the present invention includes is composed of minute filamentous forms and/or granular forms consisting of a composition containing a resin and/or inorganic microparticles. Specifically, the term “minute filamentous forms” used in the present invention means, as shown in the left figure in FIG. 1, filamentous forms 5 deposited on the surface of a substrate plastic film (3) in a relatively random pattern. The size of the filamentous forms differs depending on the conditions (voltage applied, flow rate, nozzle diameter) under which the apparatus described later is used or the types of the resin solution used; therefore, it is not limited to a specific size. However, the diameter, on the basis of the fiber diameter, is 100 μm to 1 nm and particularly preferably 10 μm to 10 nm. The smaller the diameter becomes, the more transparent filamentous forms become; thus, filamentous forms having a smaller diameter is preferable in the applications of plastic films which need transparency. The size of the minute granular forms in the present invention also differs depending on the conditions under which the apparatus is used or the types of the resin solution used. However, the diameter, on the basis of the particle diameter, is 100 μm to 1 nm and particularly preferably 10 μm to 10 nm.

The surface layer of the present invention may be made up of a single layer or several layers superimposed on one another regularly or irregularly composed of minute filamentous forms and/or granular forms deposited on the surface of a substrate plastic film. In the present invention, the surface layer may be formed to have a uniform thickness or to have a non-uniform thickness. The average thickness of the surface layer differs depending on the applications for which the surface-modified plastic film is used or the functions which are added to the surface of the plastic film: however, the average thickness is usually 100 to 0.001 μm, preferably 50 to 0.01 μm and particularly preferably 10 to 0.1 μm.

### Composition

The minute filamentous forms and granular forms constituting the surface layer of the present invention consist of a composition containing a resin and/or inorganic microparticles. In the present invention, the resin and/or inorganic microparticles mainly play a role in adding functions onto the surface of the plastic film. The term “composition” used in the present invention means a composition which contains, as an essential component, a resin, or a resin and inorganic microparticles, or inorganic microparticles. In implementing the present invention, the essential component the composition should contain is appropriately selected depending on the functions to be added to the surface-modified plastic or the applications for which the surface-modified plastic is used or the type of the substrate film used. Examples of the functions to be added include: anti-fogging properties, stain resistance, water repellency, and specific-ray reflecting properties.

In the present invention, various types of resins having been known as resins for coating can be used. Examples of such resins include: acrylic resins, urethane resins, silicon resins, acrylic urethane resins, acrylic silicon resins, acrylic modified polyolefin resins, polyolefin resins, vinyl chloride resins, vinyl chloride-vinyl acetate resins, polyester resins, and fluorine resins. The resin used may be appropriately selected depending on the type of the substrate film and the functions to be added to the substrate film. For example, to enable the substrate film to exhibit anti-fogging properties or water repellency, a hydrophobic resin or hydrophilic resin is selected.

For example, in the case of adding anti-fogging properties to a polyolefin resin substrate film, an acrylic resin or urethane resin is preferably used. Examples of acrylic resins used include: hydrophilic acrylic resins containing as monomer component, preferably 60% by weight or more of hydroxyl group-containing vinyl monomer; and hydrophobic acrylic resins containing as monomer component, less than 60% by weight of hydroxyl group-containing vinyl monomer. Examples of urethane resins include: polyether, polyester or polycarbonate anionic polyurethanes.

To apply to the electrospray deposition method of the present invention, preferably the molecular weight of the resin is high to some extent. Preferably the weight-average molecular weight of the resin is 20,000 or more, preferably 40,000 or more, and much more preferably 100,000 or more.

The measure of hydrophobic nature or hydrophilic nature may be on the basis of the plastic film to which the resin is used. Usually, the degree of the hydrophobic nature or hydrophilic nature is determined using a droplet contact angle, which is a common measure of surface wettability. Generally, a droplet contact angle of 80° or more indicates hydrophobic nature (or water repellency), whereas a droplet contact angle of 50° or less indicates hydrophilic nature. However, in the present invention, resins which decrease the droplet contact angle on the plastic film to which they are applied may be considered to be hydrophilic resins.

In the filamentous forms of the present invention, their hydrophobic or hydrophilic portions can be formed in an arbitrary pattern on part of the plastic film surface by controlling their diameter or density, whereby the wettability of the plastic film surface can be controlled. Thus, they are expected to produce various anti-fogging property-adding effects or conversely water repellency-adding effects.

For the inorganic microparticles used in the present invention, any function-adding inorganic microparticles can be employed. Examples of such inorganic microparticles include: inorganic colloid sols of silica, alumina, water-insoluble lithium silicate, iron hydroxide, tin hydroxide, titanium oxide or barium sulfate. Preferred inorganic microparticles are silica sol or alumina sol.

Preferably an inorganic colloidal sol is selected from those having an average particle diameter in the range of 5 to 200 nm. Two or more kinds of colloidal sols having different average particle diameters can also be used in combination with each other.

In the present invention, particularly in the case of adding antifogging properties, a composition is preferably used in which an acrylic resin and colloidal microparticles of silica or alumina are combined with each other.

In the present invention, in the case of adding stain resistance, a fluorine resin or an acrylic resin, which has been known as a stain-resistance material, can be used. Such resins are allowed to be filamentous forms or granular forms by the method of the present invention, whereby their performance is further improved.

Further, if a resin composition having a refractive index different from that of the substrate plastic film is used to form filamentous forms of the present invention and the diameter of the filamentous forms are controlled so that they are regularly arranged in one direction or in more than one direction and moreover formed into multiple layers each having regularity, the plastic film is made possible to reflect light having a specific wavelength utilizing the phenomenon like diffraction or interference of lights.

These resin compositions are fed, in the form of a solution or dispersion in an arbitrary solvent, to the spray nozzle of the electrospray deposition apparatus described later.

### Electrospray Deposition Method

The surface-modified plastic film of the present invention can be suitably produced by surface treatment method using electrospray deposition. The term “electrospray deposition” used in the present invention means a method in which a liquid such as a solution or dispersion is statically charged, very small droplets of the charged material are formed, and the very small droplets are deposited on an object of deposition. There is disclosed, for example, in Japanese Patent Application Laying-open No. 2002-511792 an example of forming minute films or spots from biopolymers such as proteins by electrospray deposition. However, there is practically no example of applying the electrospray deposition to a larger scale object such as a plastic film.

Specifically, the electrospray deposition method used in the present invention is as follows. A solution or dispersion wherein a resin, a resin and inorganic microparticles, or inorganic microparticles is dissolved or dispersed in a solvent, which is intended to deposit on the surface of a film, is fed to a spray nozzle having a capillary at its tip. When applying a high voltage to the spray nozzle, while applying pressure which makes the flow rate of the solution or dispersion constant, the solution or dispersion is sprayed through the capillary at the tip of the nozzle in the form of charged droplets or filamentous forms several tenth microns to several ten microns in diameter and moves rapidly away from the tip of the nozzle due to electrostatic repulsion.

In one aspect of the surface treatment method of the present invention, in the case where the substrate plastic film having a surface on which the above described composition is to be deposited (hereinafter referred to as an object of the deposition) is electrically insulating (for example, inherent surface resistance, as a measure of electrically insulating properties, is higher than 10¹⁵Ω), the substrate plastic film is, for example, placed on a conductive plate whose area is larger than that of the film so that the periphery of the film is surrounded by the conductive material, and a certain potential difference is provided between the conductive material and the spray nozzle. As a result, the charged filamentous forms having moved away from the tip of the nozzle is deposited on the film surface. In this process, almost all the volatile solvent contained in the solution or dispersion volatilizes, though it depends on the distance between the nozzle and the film, and the resin or the resin and inorganic microparticles are deposited on the object of the deposition; therefore, a drying step subsequent the process is usually unnecessary. Thus, the method is less problematic in terms of pollution or environment, compared with the commonly used roll coater coating or dip coating method in which a large amount of solvent is used.

In another aspect of the surface treatment method of the present invention, when the substrate plastic film is electrically insulating, the substrate plastic film having undergone perforating may be used. In the case where the film has been perforated, the minute filamentous forms and/or granular forms to be formed on the film surface can often be uniformly distributed on the film by locating an electrode on the back side of the film in depositing a resin using electrospray deposition. And the proportion of granular forms formed tends to be increased. The size or shape of the minute holes formed in the performed film is not limited to any specific size or shape; however, from the viewpoint of uniform-coating effect, film strength, or heat-insulating effect when the film is an agricultural film, the size is preferably 8×10⁻⁵ mm² or more and 4 mm² or less and the number of the holes per unit area of film is preferably one per 100 cm² or more. The perforating method is not limited to any specific one, either. Various types of perforating methods, such as punching using a commonly used punching die or needle, needle-pricker or laser light perforating, can be applied.

In the present invention, in the case where the electrically insulating properties of the substrate plastic film have been lowered, in other words, the substrate film contains an antistatic agent, or the surface of the substrate film has been treated with an antistatic agent, or a film containing an antistatic agent has been formed on the surface of the substrate film, the electrospray deposition can be applied directly to the film without arranging a conductive material around the film. In this case, the edge portion of the substrate plastic film must be grounded. “The electrically insulating properties of the surface of the substrate plastic film are lowered” means that the inherent surface resistance of the substrate plastic film after it undergoes treatment, e.g., a treatment with an antistatic agent, is decreased by at least 10¹ order, compared with the inherent surface resistance of the substrate plastic film before it undergoes the treatment (or which does not contain an antistatic agent or which does not include a film containing an antistatic agent).

The electrospray deposition method of the present invention is similar to a commonly used technique, which utilizes electrostatic spraying such as electrostatic coating, in principle, but actually it differs from such a technique. For example, in the commonly used electrostatic deposition technique, a charged coating powder is sprayed through a nozzle at a large flow rate and a large amount of coating composed of large-size particles is coated on a charged object of the deposition, thereby forming a coating film having a thickness of several tens μm to several hundreds μm. In contrast, in the surface treating technique using the electrospray deposition of the present invention, the deposition on the surface is controlled in the regions as small as several tenth micrometers to 10 μm, near nano-order, by arbitrarily controlling the voltage or flow rate applied. And in the present invention, particularly, minute filamentous forms are deposited on part of the surface of the electrically insulating object of the deposition in a unique pattern.

As shown in a schematic diagram of FIG. 1, a specific apparatus used in the electrospray deposition include: a spray nozzle (1) which has a capillary on its nozzle tip (1a) and flows out liquid at a fixed flow rate under pressure; a conductive plate as an object (2) which is located opposite to the nozzle and has a plastic film (3) on its plane on the nozzle side and whose plane is larger than the object of the deposition; and a device (4) which is capable of applying a voltage between the nozzle tip (1a) and the conductive plate (2). In the schematic diagram, a spray nozzle, a plastic film (3) and a conductive plate (2) are arranged laterally; however, it is also possible to provide an apparatus in which a spray nozzle is arranged on the upper side while a plastic film (3) and a conductive plate (2) are arranged on the lower side and gravity is also used to spray a liquid.

The voltage applied to the apparatus and the flow rate of a liquid can be appropriately controlled depending on the viscosity or concentration of the resin-containing liquid used; however, the voltage applied is in the range of 2 to 30 kV and preferably 10 to 20 kV and the voltage on the nozzle side may be positive or negative. Too high a voltage applied is not preferable because it causes corona discharge from the nozzle tip, whereas too low a voltage is not preferable, either, because electrostatic repulsion becomes low, whereby spraying is not caused at the nozzle tip.

The flow rate is in the range of 0 to 5.0 ml/min and preferably in the range of 0.01 to 0.5 ml/min. The diameter of the nozzle tip adopted is in the range of 0.05 to 5 mm and preferably in the range of 0.4 to 1 mm.

The physical properties of the resin-containing liquid which is applied to the electrospray deposition method are such that conductivity of the resin-containing liquid is 20 mS/m or less and particularly preferably 8 mS/m or less, viscosity is 10 cP to 1900 cP and preferably 20 cP to 300 cP, and surface tension is preferably 20.0 mN/m to 72.0 mN/m.

Too high a conductivity is a problem in that it prevents electrospraying phenomenon from occurring. Too high a viscosity makes it difficult to feed a rein-containing liquid to the spray nozzle, whereas too low a viscosity makes it difficult to control the diameter of filamentous forms or granular forms. Too high a surface tension makes electrospraying less likely to occur, whereas too low a surface tension makes it difficult to retain a solution in the spray nozzle section described later.

The proper range of these physical property values differs depending on the applied voltage or flow rate in the apparatus, or the diameter or density of the filamentous forms or granular forms to be obtained; thus, the range can be appropriately controlled by the selection of the type of resin or inorganic microparticles used, the change in composition ratio of resin to inorganic microparticles, or the type or concentration of the solvent used.

### EXAMPLES

### Example 1

### Substrate Plastic Film

Three different types of electrically insulating plastic films were prepared as substrate plastic films as described below.

### (1) Polyethylene Terephthalate Film (PET Film)

| | |
|---|---|
| Film thickness: 150 μm | Surface electrical resistance: 5.0 × 10¹⁵ Ω |

### (2) Polyolefin Film (PO Film)

| | |
|---|---|
| Film thickness: 150 μm | Surface electrical resistance: 3.0 × 10¹⁴ Ω |

A film formed from a resin composition which was obtained by adding, to a polyethylene resin, 0.1% by weight of benzophenone ultraviolet light absorber and 0.5% by weight of hindered amine light stabilizer.

### (3) Perforated Polyolefin Film (Perforated PO Film)

| | |
|---|---|
| Film thickness: 100 μm | Surface electrical resistance: 3.0 × 10¹⁴ Ω |

A film formed from a resin composition which was obtained by adding, to a polyethylene resin, 0.1% by weight of benzophenone ultraviolet light absorber and 0.5% by weight of hindered amine light stabilizer and perforated to have holes 100 μm in average diameter.

### Preparation of Resin Solution, Resin Dispersion or Resin and Inorganic Microparticle-Containing Dispersion

(1) Blend of Acrylic Resin (Hereinafter Referred to as A) with Silica Sol (E)

Acrylic resin (A): a hydrophilic acrylic resin containing 70% by weight of hydroxyethyl methacrylate (HEMA) in its monomer components.

Acrylic resin (A) solution: a solution of Acrylic resin (A) in methanol, having Acrylic resin (A) content of 30% by weight

Silica sol (E): a dispersion of colloidal silica particles with particle diameter of 30 to 50 nm being dispersed in methanol (solid content 30% by weight)

Acrylic resin (A) solution and silica sol (E) were mixed so that the weight ratio of A to E was as shown in Table-1 (the weight of E was calculated as the weight of silica), the mixture was diluted with methanol, and the resultant dispersion having a solid content of 5.0% by weight was used for experiments.

### (2) Acrylic Resin (B)

Acrylic resin obtained by solution polymerization and having the following monomer composition: methyl methacrylate/butyl methacrylate/2-hydroxyethyl methacrylate/methacrylic acid=50/25/24/1 (weight ratio)

Acrylic resin (B) solution: a solution of Acrylic resin (B) in isopropyl alcohol, having Acrylic resin (B) content of 15% by weight was used for experiments.

### (3) Acrylic Resin (C)

Acrylic resin obtained by emulsion polymerization and having the following monomer composition: methyl methacrylate/butyl methacrylate/styrene/methacrylic acid=30/25/44/1 (weight ratio)

Acrylic resin (C) water-dispersion: a dispersion of Acrylic resin (C) in water, having Acrylic resin (C) content of 35% by weight was used for experiments.

### Rough Description of Apparatus

As is shown in the schematic diagram of FIG. 1, was used an apparatus in which a 10 cm×10 cm plastic film is arranged opposite to spray nozzle 1 having nozzle tip 1a and enabling a solution to flow out at a given flow rate and is placed on conductive plate 2 which is made up of a 15 cm×15 cm conductive aluminum plate, and which is capable to apply a voltage between nozzle 1a and conductive plate 2.

Voltage applied: 15 kV (the nozzle side: positive voltage), Flow rate: 0.02 ml/min, Distance between nozzle and conductive plate: 10 cm, Diameter of nozzle tip: 1 mm

### Surface Treatment

Experiments were carried out, using solutions 1 to 5 which were prepared by varying the resin (A)/inorganic microparticles (E) composition ratio (weight ratio) as shown in Table-1 below, resin (B) or resin (C) on the above apparatus under the above conditions, in such a manner as to spray each of the solutions containing the respective resin compositions on the surface of each of the three different types of plastic films.

The results were such that when solutions 1 to 6 (Examples 1 to 5 where PET films were used and Examples 6 to 11 where PO films were used) were used, deposits of filamentous forms having the respective resin compositions were observed on the plastic films, and when solution 7 was used, a deposit of granular forms having the resin composition was observed on the plastic film (Example 12).

The observations, with a scanning electron microscope (SEM), of the surface conditions of the surface-modified PO film of the present invention obtained in Examples 6 to 10 are shown in FIGS. 2 to 6. The scanning electron micrographs of the surface-modified PO films of the present invention obtained in Examples 11 and 12 (perforated substrate films were used) are shown in FIGS. 7 and 8. The ratio of the resin (A) and the inorganic microparticles (E) was 3:1 in the film shown in FIG. 2 (Example 6), 2:1 in the film shown in FIG. 3 (Example 7), 1:1 in the film shown in FIG. 4 (Example 8), 1:2 in the film shown in FIG. 5 (Example 9,) and 1:3 in the film shown in FIG. 6 (Example 10). FIGS. 2 to 6 are all enlarged views obtained at the same magnification. Comparison between the films of FIGS. 2 to 6 shows that the diameter of the filamentous forms decreases with the increase in the proportion of inorganic microparticles.

The fiber diameter of the filamentous forms (the particle diameter of the granular forms) obtained in Examples 1 to 12 is shown in Table-2. The results show that the fiber diameter of the filamentous forms decreases with the increase in the ratio of the inorganic microparticle content to the resin.

To verify the above results, the deposits of the filamentous forms on the films obtained in Examples 1 to 10 were subjected to Si atom detection by energy dispersive X-ray analysis (EDX). The analysis confirmed the existence of Si atoms originated from the inorganic microparticles in the deposits of the filamentous forms.

Further, the PO films before and after the surface treatment were measured for their contact angle. The measurement of the contact angle was carried out by droplet method (temperature: 24° C., humidity: 26%, liquid: 2 μL of distilled water, measurement: averaging the measurements at 5 points). The results confirmed that though the contact angle in the untreated PO film (2) was 91.8°, the contact angle in the film after surface treatment with solution 2 (A/E=2:1) was changed to 57.6° (made hydrophilic). The results also confirmed that though the contact angle of the untreated perforated PO film (3) was 70.1°, the contact angle in the film after surface treatment with solution 7 (solution C) was changed to 84.3° (made hydrophobic).

TABLE 1
Liquid composition used

| | Composition | Electrical | | |
|---|---|---|---|---|
| Type of | ratio (weight | conductivity | Viscosity | Surface tension |
| liquid | ratio) | (mS/m) | (cP) | (mN/m) |
| Liquid 1 | A/E = 3:1 | 2.2 | 32.0 | 24.6 |
| Liquid 2 | A/E = 2:1 | 2.3 | 26.7 | 24.5 |
| Liquid 3 | A/E = 1:1 | 3.3 | 17.1 | 23.8 |
| Liquid 4 | A/E = 1:2 | 5.2 | 10.1 | 24.1 |
| Liquid 5 | A/E = 1:3 | 6.7 | 7.6 | 24.8 |
| Liquid 6 | B alone | — | 22.7 | 22.8 |
| Liquid 7 | C alone | 175.1 | 46.2 | 38.4 |

TABLE 2
Examples and Comparative examples

| | | | | | | Diameter of |
|---|---|---|---|---|---|---|
| | | Diameter of | | Diameter of | | filamentous |
| | | filamentous | | filamentous | | forms/granular |
| Liquid | (1) PET | forms on PET | | forms on PO | (3) Perforated | forms on perforated |
| used | film | film (μm) | (2) PO film | film (μm) | PO film | PO film (μm) |
| Liquid 1 | Example 1 | 4.4 | Example 6 | 5.0 | | |
| Liquid 2 | Example 2 | 2.9 | Example 7 | 3.1 | | |
| Liquid 3 | Example 3 | 1.5 | Example 8 | 1.7 | | |
| Liquid 4 | Example 4 | 1.0 | Example 9 | 1.1 | | |
| Liquid 5 | Example 5 | 0.6 | Example 10 | 0.6 | | |
| Liquid 6 | | | | | Example 11 | 10 (filamentous |
| | | | | | | forms) |
| Liquid 7 | | | | | Example 12 | 0.1 to 0.2 (granular |
| | | | | | | forms) |

### Example 2

Experiments were carried out by electrospray deposition method on substrate plastic films whose electrically insulating properties have been lowered. The substrate films used were prepared as follows.

### Preparation of Substrate Plastic Films

(1) Substrate film 1: Film prepared by blending vinyl chloride resin with 9 parts by weight of carbon black and calendaring.

| | |
|---|---|
| Film thickness: 100 μm | Surface electrical resistance: 8.7 × 10³ Ω |

(2) Substrate film 2: Film prepared by spraying an antistatic agent on the surface of the same type of polyolefin film as used in Example 1.

| | |
|---|---|
| Film thickness: 150 μm | Surface electrical resistance: 1.3 × 10¹⁰ Ω |

Antistatic agent used: DryMax SX-250 (a solution of alkyldiethanol amide in ethanol) manufactured by Sunhayato Corp.

(3) Substrate film 3: Film prepared by coating the surface of the same type of polyethylene terephthalate film as used in Example 1 with a solution containing ATO and acrylic resin using a reverse-roll coater and drying the same.

| | |
|---|---|
| Film thickness: 150 μm | Surface electrical resistance: 8.0 × 10¹³ Ω |

(4) Substrate film 4: Film prepared by blending vinyl chloride resin with 7 parts by weight of antistatic plasticizer (adipate plasticizer) and calendaring.

| | |
|---|---|
| Film thickness: 300 μm | Surface electrical resistance: 1.2 × 10¹⁴ Ω |

(5) Substrate film 5 (Comparative example): The same type of polyolefin film as used in Example 1.
(6) Substrate film 6 (referential example): Aluminum foil

Thickness: 50 μm

### Preparation of Resin Solution and Inorganic Microparticle Dispersion

The following resin solution and inorganic microparticle dispersion were used.

(1) Liquid 9: A solution of the same type of acrylic resin A as used in Example 1 in methanol having Acrylic resin (A) content of 30% by weight. Viscosity (20° C.): 60 mPa
(2) Liquid 10: A dispersion of colloidal silica particles having a particle diameter of 30 to 50 nm in dispersed isopropyl alcohol (solid content 30% by weight)

### Rough Description of Apparatus

The same type of apparatus as used in Example 1 was used and a 10 cm×10 cm substrate plastic film was arranged opposite to the spray nozzle enabling a solution to flow out at a given flow rate. The apparatus was grounded directly by the surface of the substrate plastic film.

Voltage applied: 15 kV (the nozzle side: positive voltage), Flow rate: 0.01 ml/min, Distance between nozzle and substrate film: 10 cm, Diameter of nozzle tip: 0.5 mm

### Surface Treatment

Experiments were carried out, using liquids 9 to 10 described above on the above apparatus under the above conditions, in such a manner as to spray each of the liquids containing the respective resin compositions on the surface of each of the six different types of substrates (five different types of plastic films and one type of aluminum foil).

The results were such that in substrate films 1 to 4, when liquid 9 was used, deposits of filamentous forms were observed on the plastic films (Examples 13 to 16). When liquid 10 was sprayed on the substrate films 2 and 6, deposits of granular forms were observed on both of the substrate films (Example 17 and Referential example 1). The fiber diameter of the filamentous forms (the particle diameter of the granular forms) obtained in Examples 13 to 20 and measurements of droplet contact angle are shown in Table-3. And the observations, with SEM, of the surface conditions of the surface-treated plastic films obtained in Examples 13 to 17 are shown in FIGS. 9 to 13. The results show that a surface-modified film of the present invention can be obtained by decreasing the electrically insulating properties of the substrate films even if a conducting material such as an aluminum plate is not arranged around the periphery of the substrate films.

TABLE 3
Examples and Comparative examples

| | | Diameter of | Contact | | Diameter of | Contact |
|---|---|---|---|---|---|---|
| Substrate | | filamentous | angle of | | granular forms | angle of |
| film | Liquid 9 | forms (μm) | droplets | Liquid 10 | (μm) | droplets |
| 1 | Example 13 | 2.1 | 40° | | | |
| 2 | Example 14 | 1.3 | 10° | Example 17 | 1.4 | 8° |
| 3 | Example 15 | 1.7 | 16° | | | |
| 4 | Example 16 | 1.5 | 15° | | | |
| 5 | Comparative | x | | Comparative | x | |
| | example 1 | | | example 2 | | |
| 6 | | | | Referential | 1.5 | 52° |
| | | | | example 1 | | |

“x mark” . . . No deposits (filamentous forms or granular forms) could be formed on the substrate plastic films.

### BRIEF DESCRIPTION OF THE DRAWINGS

FIG. 1 is a schematic diagram showing the apparatus used in the present invention and the outline of the electrospray deposition method used in Example 1;

FIG. 2 is an enlarged view of the filamentous forms obtained in Example 6 of the present invention;

FIG. 3 is an enlarged view of the filamentous forms obtained in Example 7 of the present invention;

FIG. 4 is an enlarged view of the filamentous forms obtained in Example 8 of the present invention;

FIG. 5 is an enlarged view of the filamentous forms obtained in Example 9 of the present invention;

FIG. 6 is an enlarged view of the filamentous forms obtained in Example 10 of the present invention;

FIG. 7 is an enlarged view of the filamentous forms obtained in Example 11 of the present invention;

FIG. 8 is an enlarged view of the granular forms obtained in Example 12 of the present invention;

FIG. 9 is an enlarged view of the filamentous forms obtained in Example 13 of the present invention;

FIG. 10 is an enlarged view of the filamentous forms obtained in Example 14 of the present invention;

FIG. 11 is an enlarged view of the filamentous forms obtained in Example 15 of the present invention;

FIG. 12 is an enlarged view of the filamentous forms obtained in Example 16 of the present invention; and

FIG. 13 is an enlarged view of the granular forms obtained in Example 17 of the present invention.

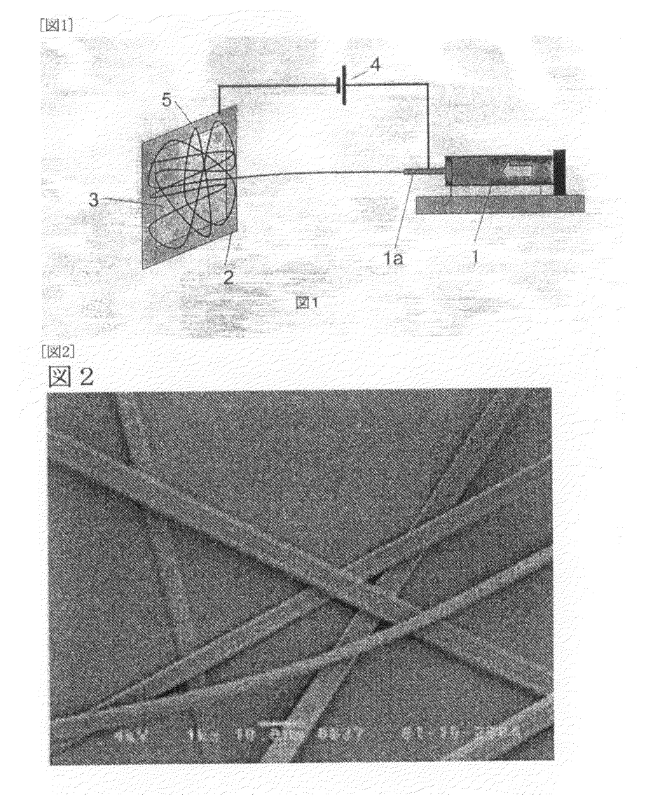

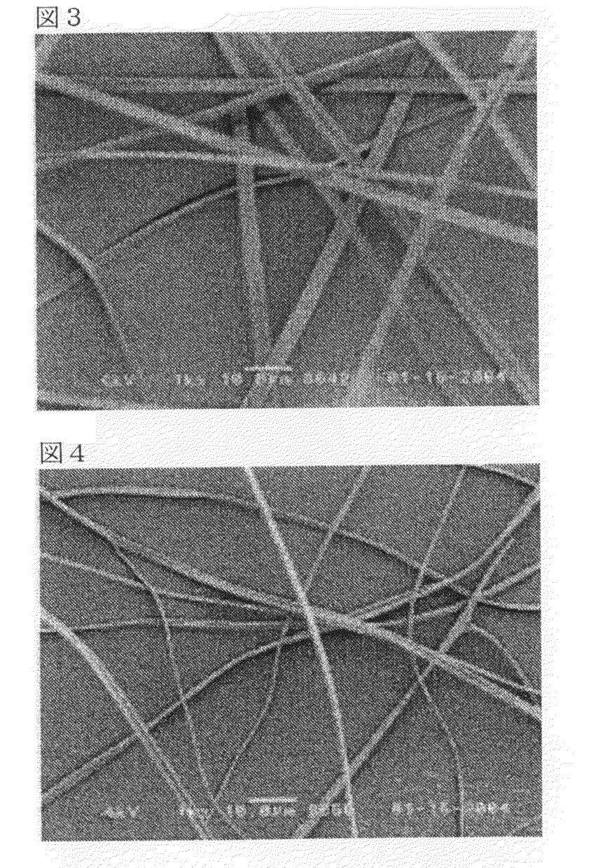

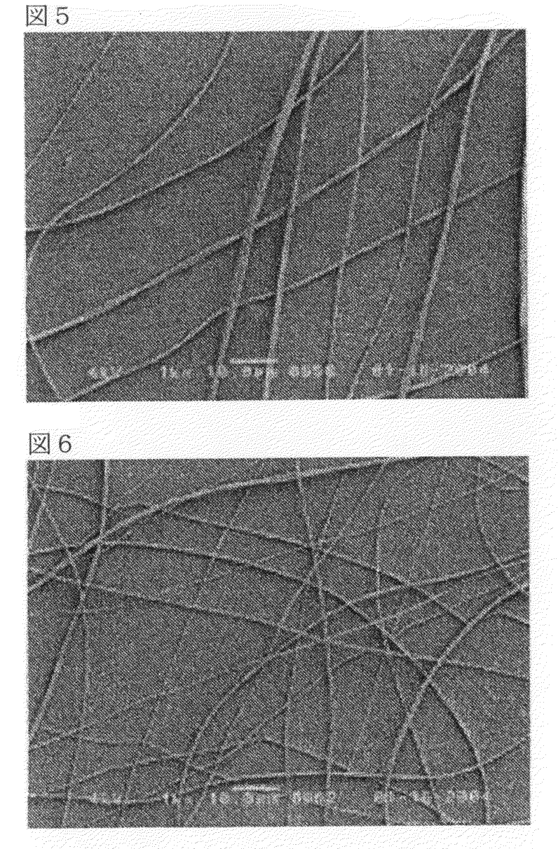

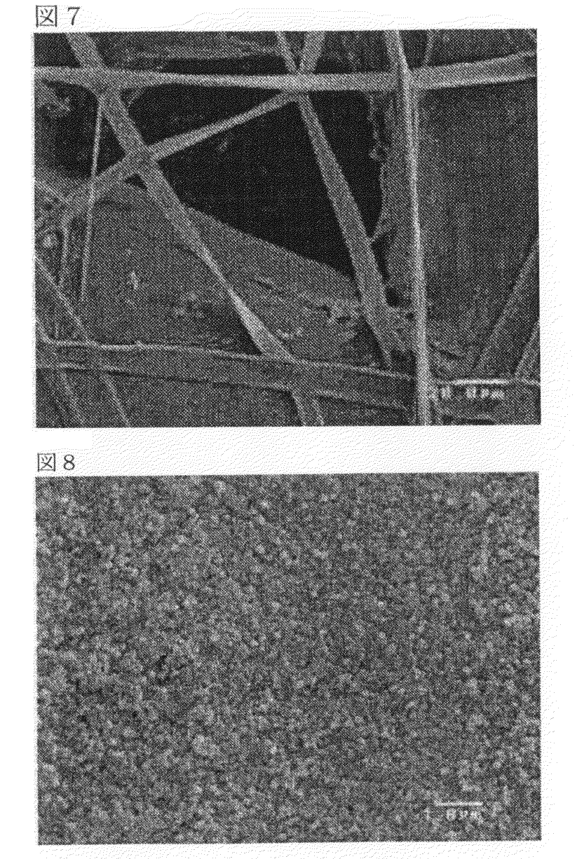

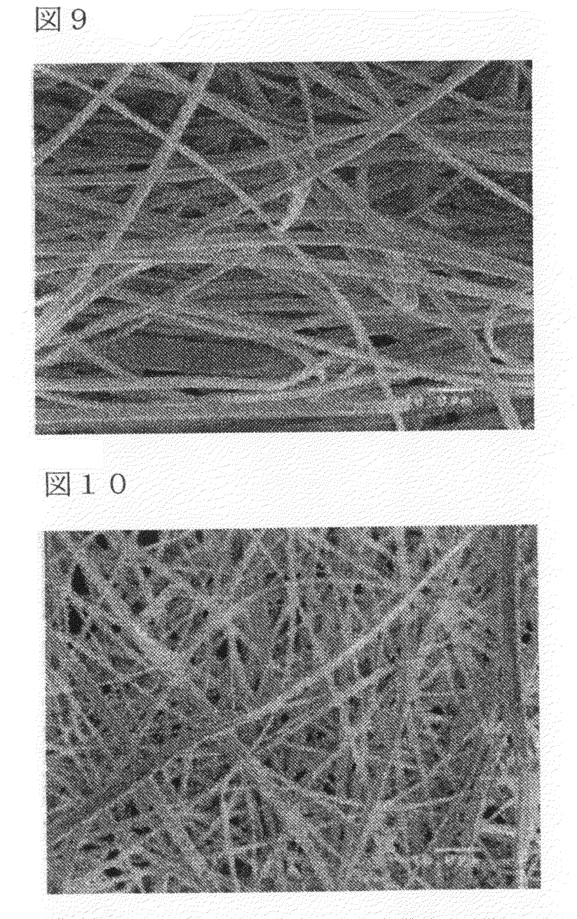

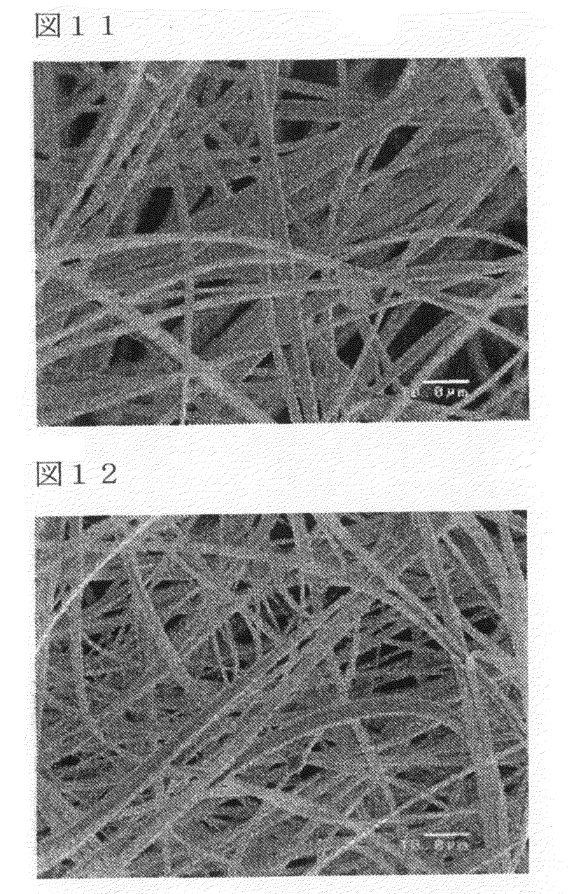

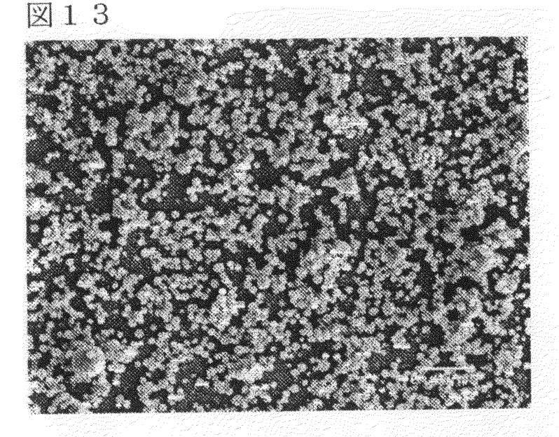

### DESCRIPTION OF THE REFERENCE NUMERALS

1 Spray nozzle
1a Nozzle tip
2 Conductive plate
3 Plastic film
4 Voltage applier
5 Filamentous forms

1. A surface-modified plastic film, comprising: a surface layer composed of minute filamentous forms and/or granular forms consisting of a composition containing a resin and/or inorganic microparticles, on at least one major surface of a substrate plastic film.

2. The surface-modified plastic film according to claim 1, wherein the surface layer is formed by deposition.

3. The surface-modified plastic film according to claim 1 or 2, wherein the substrate plastic film detected contains an antistatic agent.

4. The surface-modified plastic film according to any one of claims 1 to 3, further comprising a conductive film between the substrate plastic film and the surface layer.

5. The surface-modified plastic film according to any one of claims 1 to 4, wherein the surface of the substrate plastic film on which the surface layer is to be formed is treated with an antistatic agent.

6. The surface-modified plastic film according to any one of claims 1 to 5, further comprising a primer layer between the substrate plastic film and the surface layer.

7. The surface-modified plastic film according to any one of claims 1 to 6, wherein the substrate plastic film is a perforated film.

8. The surface-modified plastic film according to any one of claims 1 to 7, wherein the minute filamentous forms and/or granular forms are 100 μm to 1 nm in diameter.

9. The surface-modified plastic film according to any one of claims 1 to 8, wherein the minute filamentous forms are arranged regularly at least in one direction on the electrically insulating film.

10. The surface-modified plastic film according to any one of claims 1 to 9, wherein the surface layer is formed by electrospray deposition method.

11. The surface-modified plastic film according to any one of claims 1 to 10, wherein the resin is a hydrophobic or hydrophilic resin, and said surface-modified plastic film is provided with anti-fogging properties.

12. The surface-modified plastic film according to any one of claims 1 to 11, wherein the resin is a hydrophobic or hydrophilic resin, and said surface-modified plastic film is provided with water repellency.

13. The surface-modified plastic film according to any one of claims 1 to 12, wherein the composition is a resin composition having a refractive index different from that of the substrate plastic film, and said surface-modified plastic film reflects light having a specific wavelength.

14. A process for preparing a surface-modified plastic film, comprising spraying droplets of a solution or dispersion containing a resin and/or inorganic microparticles using electrospray deposition, on at least one major surface of a substrate plastic film, around which a conductive material is arranged in a manner to surround a periphery of the substrate plastic film, whereby a surface layer composed of minute filamentous forms and/or granular forms consisting of a composition containing the resin and/or inorganic microparticles being formed on a surface of said substrate film.

15. A process for preparing a surface-modified plastic film, comprising spraying droplets of a solution or dispersion containing a resin and/or inorganic microparticles using electrospray deposition, on at least one major surface of a substrate plastic film whose electrically insulating properties is lowered, whereby a surface layer composed of minute filamentous forms and/or granular forms consisting of a composition containing the resin and/or inorganic microparticles being formed on a surface of said substrate film.

16. A process for preparing a surface-modified plastic film, comprising spraying droplets of a solution or dispersion containing a resin and/or inorganic microparticles using electrospray deposition, on one major surface of a perforated substrate plastic film, said surface being opposite to a surface on which a conductive material is arranged, whereby a surface layer composed of minute filamentous forms and/or granular forms consisting of a composition containing the resin and/or inorganic microparticles being formed on a surface of said substrate film.
